(19) United States
(12) Patent Application Publication
(10) Pub. No.: US 2026/0365169 A1
(43) Pub. Date: Nov. 19, 2026

(54) STOP POSITION ESTIMATION DEVICE

(71) Applicant: HONDA MOTOR CO., LTD., Tokyo (JP)

(72) Inventors: Ryogo MATSUMOTO, Tokyo (JP); Tomokazu MITSUI, Tokyo (JP); Yuki KIZUMI, Tokyo (JP)

(73) Assignee: HONDA MOTOR CO., LTD., Tokyo (JP)

(21) Appl. No.: 19/575,954

(22) Filed: Mar. 24, 2026

(30) Foreign Application Priority Data
Mar. 28, 2025 (JP) 2025-056562

(51) Int. Cl. B60W 30/18

(52) U.S. Cl. CPC B60W 30/18109; B60W 2552/53; B60W 2554/4041; B60W 2556/40

(57) ABSTRACT

A stop position estimation device that estimates a stop position of a vehicle based on information indicating a position of an intersection and a number of lanes of a road includes a processor configured to estimate, when a traveling road intersects with a crossing road, the stop position at an intersection, the traveling road being a road on which the vehicle travels, the crossing road being a road different from the traveling road. The processor uses a position of the intersection, based on the map information, as a reference, and estimates, as the stop position, a position located at a distance from the intersection on a vehicle side of the intersection, the distance being a sum of a first adjustment distance according to a number of lanes of the crossing road and a predetermined second adjustment distance corresponding to a corner cut of the intersection.

### CROSS-REFERENCE TO RELATED APPLICATIONS

This application is based on and claims priority under 35 USC 119 from Japanese Patent Application No. 2025-056562 filed on Mar. 28, 2025, the entire content of which is incorporated herein by reference.

### TECHNICAL FIELD

The present disclosure relates to a stop position estimation device.

### BACKGROUND ART

In recent years, active efforts have been made to provide access to a sustainable transportation system in consideration of vulnerable traffic participants. As one of these efforts, research and development on driving assist techniques and automated driving techniques for vehicles such as automobiles have been made in order to further improve safety and convenience of traffic.

As an example of the driving assistance techniques, JP2023-013304A discloses a technique in which when a stop line is detected based on map information stored in a high-definition road map database, a host vehicle is decelerated at a deceleration calculated based on a distance from the host vehicle to the stop line.

### SUMMARY OF INVENTION

In the related art, for example, map information including stop line information such as the high-definition road map database is required. However, since general map information often does not include information on the stop line, a technique for accurately estimating an appropriate stop position even if no information on the stop line is included in the map information is desired.

Aspect of non-limiting embodiments of the present disclosure relates to providing a stop position estimation device that estimates a stop position of a vehicle based on map information including information indicating a position of an intersection and a number of lanes of a road connected to the intersection, the stop position estimation device including a processor configured to estimate, when a traveling road intersects with a crossing road, the stop position at an intersection of the traveling road and the crossing road, the traveling road being a road on which the vehicle travels, the crossing road being a road different from the traveling road, in which the processor uses a position of the intersection of the traveling road and the crossing road, based on the map information, as a reference, and estimates, as the stop position, a position located at a distance from the intersection on a vehicle side of the intersection, the distance being a sum of a first adjustment distance according to a number of lanes of the crossing road and a predetermined second adjustment distance corresponding to a corner cut of the intersection.

According to an aspect of the present disclosure, there is provided a stop position estimation device that estimates a stop position of a vehicle based on map information including information indicating a position of an intersection and a number of lanes of a road connected to the intersection, the stop position estimation device including a processor configured to estimate, when a traveling road intersects with a crossing road, the stop position at an intersection of the traveling road and the crossing road, the traveling road being a road on which the vehicle travels, the crossing road being a road different from the traveling road, in which the processor uses a position of the intersection of the traveling road and the crossing road, based on the map information, as a reference, and estimates, as the stop position, a position at a predetermined distance from the intersection on a side closer to the vehicle, the distance being a sum of a first adjustment distance according to a number of lanes of the crossing road and a predetermined second adjustment distance corresponding to a corner cut of the intersection.

The present disclosure can provide a stop position estimation device that can accurately estimate an appropriate stop position even if information on stop lines is not included in map information.

### BRIEF DESCRIPTION OF DRAWINGS

Exemplary embodiment(s) of the present invention will be described in detail based on the following figures, wherein:

FIG. 1 is a block diagram illustrating a schematic configuration of a vehicle 1 including a control device 30 that is an exemplary embodiment of a stop position estimation device of the present invention;

FIG. 2 is a diagram (part 1) illustrating a method for estimating a stop position SL;

FIG. 3 is a diagram (part 2) illustrating the method for estimating the stop position SL;

FIG. 4 is a diagram (part 3) illustrating the method for estimating the stop position SL;

FIG. 5 is a diagram (part 4) illustrating the method for estimating the stop position SL;

FIG. 6 is a diagram (part 5) illustrating the method for estimating the stop position SL;

FIG. 7 is a diagram (part 6) illustrating the method for estimating the stop position SL;

FIG. 8 is a flowchart (part 1) illustrating an example of a processing procedure by the control device 30;

FIG. 9 is a flowchart (part 2) illustrating the example of the processing procedure by the control device 30;

FIG. 10 is a flowchart (part 3) illustrating the example of the processing procedure by the control device 30;

FIG. 11 is a flowchart (part 4) illustrating the example of the processing procedure by the control device 30;

FIG. 12 is a flowchart (part 5) illustrating the example of the processing procedure by the control device 30; and

FIG. 13 is a flowchart (part 6) illustrating the example of the processing procedure by the control device 30.

### DESCRIPTION OF EMBODIMENTS

Hereinafter, an embodiment of a stop position estimation device of the present disclosure will be described with reference to the drawings. The drawings are viewed in directions of reference signs. The following embodiment does not limit the present invention, and not all of elements described in the following embodiment are essential to the present invention. Two or more elements described in the following embodiment may be freely combined without departing from the gist of the present invention. Hereinafter, the same or similar elements are denoted by the same or similar reference signs, and descriptions thereof may be omitted or simplified.

In the present description and the like, in order to simplify and clarify the description, front-rear (including near-far), left-right, and upper-lower directions are described according to directions seen from a driver who is an occupant of a vehicle (a vehicle 1 to be described later), and in the drawings, a front side of the vehicle is denoted by Fr, a rear side is denoted by Rr, a left side is denoted by L, and a right side is denoted by R.

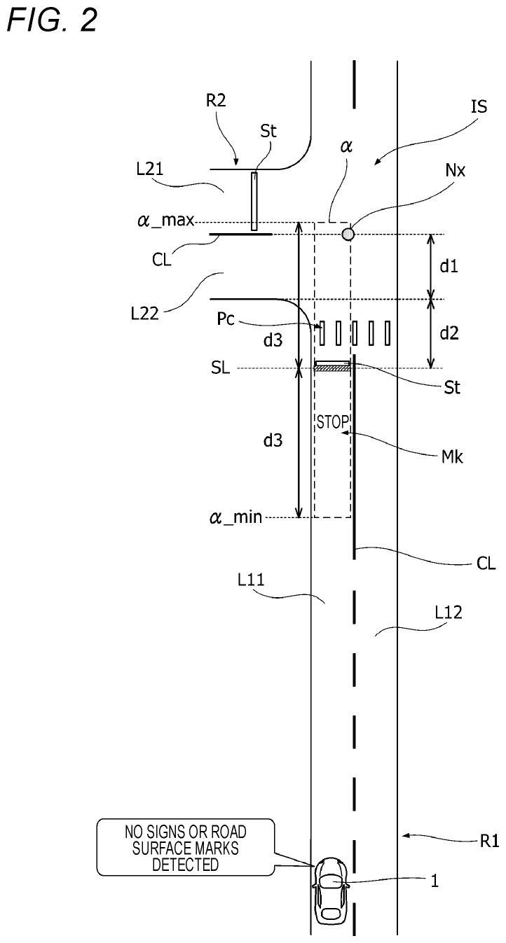

Further, the following embodiment will assume a left-hand traffic region such as Japan and describe an example in which one side in a vehicle width direction in the present disclosure is set to a left side and the other side in the vehicle width direction is set to a right side, but is not limited thereto. For example, when the present disclosure is applied to a right-hand traffic region such as the United States of America or the People's Republic of China, the one side in the vehicle width direction in the present disclosure may be set to the right side, and the other side in the vehicle width direction may be set to the left side. In this case, “turn right” and “turn left” in the following description may be interpreted as “turn left” and “turn right”, respectively, and FIGS. 2 to 7 may be viewed with the left and right reversed as necessary.

### 1. Vehicle

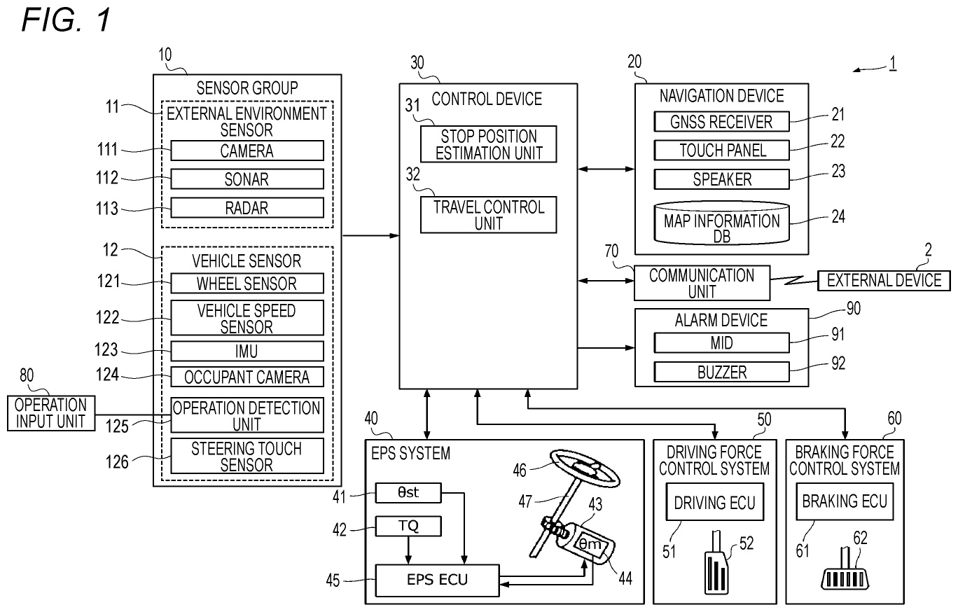

FIG. 1 is a block diagram illustrating a schematic configuration of a vehicle 1 including a control device 30 that is an exemplary embodiment of a stop position estimation device of the present invention. The vehicle 1 according to the present embodiment illustrated in FIG. 1 is an automobile including a drive source (not illustrated), and wheels (not illustrated) including drive wheels driven by power of the drive source and steered wheels that are steerable. As an example, the vehicle 1 can be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 includes a sensor group 10, a navigation device 20, the control device 30, an electric power steering (EPS) system 40, a driving force control system 50, a braking force control system 60, a communication unit 70, an operation input unit 80, and an alarm device 90.

The sensor group 10 includes an external environment sensor 11 that acquires information related to a periphery of the vehicle 1 (hereinafter referred to as “external environment information”), and a vehicle sensor 12 that acquires information related to the vehicle 1. The information (in other words, a detection value) acquired by each sensor in the sensor group 10 is output to the control device 30, and is used by the control device 30 to control the vehicle 1.

The external environment sensor 11 includes, for example, cameras 111, a sonar 112, and a radar 113. The camera 111 is an imaging device that images the surroundings of the vehicle 1 including the front of the vehicle 1 and outputs image data of an obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves to the periphery of the vehicle 1 (for example, the front side, a rear side, and lateral sides of the vehicle 1), and receives reflected sounds from an object present in the periphery of the vehicle 1, thereby detecting a distance to the object, a direction of the object, and the like. The radar 113 emits radio waves to the periphery of the vehicle 1 including the front side of the vehicle 1, and receives reflected waves from an object present in the periphery of the vehicle 1, thereby detecting a distance to the object, an azimuth of the object, and the like. As the radar 113, for example, a millimeter wave radar can be adopted.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects a rotation angle of each of a left rear wheel and a right rear wheel. The wheel sensor 121 may be, for example, an angle sensor or a displacement sensor.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a countershaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 may be a so-called “driver monitor camera” that is capable of imaging the head of an occupant who sits on the driver's seat of the vehicle 1 (hereinafter, also referred to as a “driver”) from the front (in other words, imaging the face). As the occupant camera 124, a digital camera using an imaging element such as a CCD or a CMOS can be adopted, similarly to the camera 111.

The operation detection unit 125 detects an operation performed by using the operation input unit 80 that is operable by the driver. In the present embodiment, the operation input unit 80 may include, for example, an operation button for receiving an operation to switch between on (in other words, operation) and off (in other words, non-operation) of predetermined driving assistance control such as deceleration control performed by a travel control unit 32, which will be described later. In this case, the operation detection unit 125 can detect an operation of turning on or off the predetermined driving assist control.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the driver when the steering 46 is gripped appropriately.

The navigation device 20 includes, for example, a global navigation satellite system (GNSS) receiver 21, a touch panel 22, and a speaker 23. The navigation device 20 includes a storage unit (not illustrated) implemented by a flash memory or the like. The storage unit of the navigation device 20 stores a map information database (hereinafter referred to as map information DB) 24 as an example of a map information or the like.

The map information DB 24 includes road network information. The road network information is information representing roads based on a combination of nodes and links connecting the nodes (also referred to as “paths”). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of a corresponding link, a road corresponding to the corresponding link, a link length, the number of lanes, a traveling direction, a road type, and the like is set. In other words, the map information DB 24 includes, for example, information indicating a position of an intersection and the number of lanes of roads connected to the intersection.

Note that in the present embodiment, the map information DB 24 can be, for example, a standard definition map (SD map) that is general map information. The SD map is map information having a smaller amount of information than high-definition map information called “HD map”. Such an SD map may not include, for example, information on a stop line St (for example, information indicating a position of the stop line St) to be described later. Since the SD map and the HD map are known, detailed description thereof will be omitted here.

The GNSS receiver 21 specifies a current position of the vehicle 1 (for example, a latitude and a longitude of a location where the vehicle 1 is at) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output sound to an occupant (for example, a driver) of the vehicle 1.

For example, the navigation device 20 searches for a route from a current position of the vehicle 1 to a destination set by the driver using the touch panel 22 by referring to the map information database 24. Then, the navigation device 20 performs route guidance using the touch panel 22 and the speaker 23 based on the found route. The navigation device 20 may cause the touch panel 22 to perform a predetermined display according to an instruction from the control device 30. Further, the navigation device 20 may output, to the control device 30, information indicating the identified current position of the vehicle 1 or predetermined information (for example, information indicating an operation received via the touch panel 22).

In the present embodiment, the control device 30 is configured to refer to the map information DB 24 (that is, the map information) of the navigation device 20. However, the present invention is not limited thereto, and map information including the road network information similar to that of the map information DB 24 may be separately stored in the control device 30 or the like, and the control device 30 may refer to such map information. Further, the control device 30 may appropriately acquire the map information from an external device 2 via the communication unit 70 to be described later or the like.

The control device 30 is a computer that includes, for example, a processor that performs various calculations, a storage unit having a non-transitory storage medium (for example, a flash memory) for storing various types of information, and an input and output unit that controls input and output of data between the inside and the outside of the control device 30 (none is illustrated), and generally controls the entire vehicle 1. For example, the control device 30 is implemented by one electronic control unit (ECU) or by a plurality of ECUs working in cooperation with each other.

In the present embodiment, for example, the control device 30 is configured to recognize a surrounding situation of the vehicle 1 based on information (for example, point cloud information) obtained by performing predetermined sensor fusion processing on detection results of a part or all of the cameras 111, the sonar 112, and the radar 113 provided in the external environment sensor 11.

For example, the control device 30 recognizes a position, a type, a speed, an acceleration, and the like of the object present in the periphery of the vehicle 1 as the surrounding situation of the vehicle 1. At this time, the control device 30 recognizes the position of the object as, for example, a position on an absolute coordinate system in which a predetermined representative point such as a center of gravity or a center of a drive shaft of the vehicle 1 is set as an origin. In the absolute coordinate system, the position of the object may be represented using a representative point such as a center of gravity or a corner of the object, or may be represented as an area.

Examples of the object that can be recognized by the control device 30 include road division lines such as division lines for separating lanes, curbs, and medians, road structures such as guard rails and road shoulders, road surface marks, road signs, stop lines, and pedestrian crossings. Further, the control device 30 may also recognize, for example, other road events such as traffic lights, branches, merging, interchanges, and tollgates of toll roads, and traffic participants such as other vehicles and pedestrians.

The control device 30 is configured to estimate a stop position SL where the vehicle 1 should stop. Since a specific control example of the control device 30 will be described later, a description thereof will be omitted here.

The EPS system 40 includes, for example, a steering angle sensor 41, a torque sensor 42, an EPS motor 43, a resolver 44, and an EPS ECU 45.

The steering angle sensor 41 detects a steering angle θst of a steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the driver in operating the steering wheel 46 by applying, according to an instruction from the EPS ECU 45, a driving force or a reaction force to a steering column 47 connected to the steering wheel 46. The resolver 44 detects a rotation angle θm of the EPS motor 43 and outputs information indicating the detected rotation angle θm to the EPS ECU 45.

The EPS ECU 45 is a computer that includes, for example, a processor that performs various calculations, a storage unit including a non-transitory storage medium for storing various types of information, and an input and output unit that controls input and output of data between the inside and the outside of the EPS ECU 45 (all of which are not illustrated), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, and the rotation angle θm detected by the resolver 44. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor that performs various calculations, a storage unit including a non-transitory storage medium for storing various types of information, and an input and output unit that controls input and output of data between the inside and the outside of the drive ECU 51 (all of which are not illustrated), and controls the driving force control system 50. The drive ECU 51 is implemented by one or a plurality of ECUs. For example, the drive ECU 51 controls power output from the drive source of the vehicle 1, based on an operation on an accelerator pedal 52 provided in the vehicle 1. The drive ECU 51 can also control the driving force control system 50 (for example, the drive source) according to an instruction from the control device 30.

The braking force control system 60 includes a brake ECU 61, and is configured to control a braking force of the vehicle 1. The brake ECU 61 is a computer that includes, for example, a processor configured to perform various calculations, a storage unit having a non-transitory storage medium for storing various types of information, and an input and output unit configured to control input and output of data between the inside and the outside of the brake ECU 61 (none illustrated), and controls the braking force control system 60. The brake ECU 61 is implemented by one or more ECUs. For example, the brake ECU 61 controls the braking force of the vehicle 1 by controlling a brake device (not illustrated) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates the hydraulic pressure in the cylinder. The brake ECU 61 controls the electric motor of the brake device such that a braking force corresponding to the operation on the brake pedal 62 is generated. The brake ECU 61 can also control the braking force control system 60 (for example, the brake device) according to an instruction from the control device 30.

The communication unit 70 is a communication interface that communicates with an external device 2 under the control of the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be used for communication between the vehicle 1 and the external device 2.

The alarm device 90 is a device that alarms the driver under control of the control device 30. The alarm device 90 includes, for example, a multi-information display (MID) 91 and a buzzer 92.

The MID 91 is implemented by a display device such as a liquid crystal display or an OLED, and is provided at a position that the driver can visually recognize (for example, in a meter panel of the vehicle 1). For example, the MID 91 displays a predetermined alarm image in accordance with an instruction from the control device 30. Note that the MID 91 may be integrated with the touch panel 22 described above.

The buzzer 92 is configured to output a predetermined alarm sound. For example, the buzzer 92 outputs a predetermined alarm sound in accordance with an instruction from the control device 30. The buzzer 92 may be integrated with the speaker 23 described above.

### 2. Control Device

Next, the control device 30 will be described in more detail. As illustrated in FIG. 1, the control device 30 includes, for example, a stop position estimation unit 31, and the travel control unit 32. Each of these functional units is implemented by, for example, the processor of the control device 30 executing the program stored in the storage unit.

When the vehicle 1 passes a location where the vehicle 1 should stop, the stop position estimation unit 31 estimates the stop position SL of the vehicle 1 at that location. Here, examples of the location where the vehicle 1 should stop include intersections including roundabouts, temporary stopping areas, and pedestrian crossings. The location where the vehicle 1 should stop may also include railroad crossings, toll booths, and the like.

As an example, in the present embodiment, as will be described below, when a traveling road R1 (see, for example, FIG. 2), which is a road on which the vehicle 1 is traveling, intersects with a crossing road R2 (see, for example, FIG. 2), which is a road different from the traveling road R1, the stop position estimation unit 31 estimates the stop position SL at an intersection IS, which is an intersection between the traveling road R1 and the crossing road R2.

The estimation of the stop position SL by the stop position estimation unit 31 includes estimation of the stop position SL based on the map information DB 24 (for example, an SD map) and estimation of the stop position SL based on a detection result of the external environment sensor 11 and the like. Furthermore, the estimation of the stop position SL based on the detection result of the external environment sensor 11 may include estimation of the stop position SL based on an advance warning sign detected by the external environment sensor 11, estimation of the stop position SL based on a road sign detected by the external environment sensor 11, and estimation of the stop position SL based on a road surface mark detected by the external environment sensor 11. These will all be described below, and therefore detailed description thereof will be omitted here.

The travel control unit 32 performs the travel control on the vehicle 1 based on the stop position SL estimated by the stop position estimation unit 31. For example, the travel control unit 32 performs deceleration control on the vehicle 1 based on the stop position SL estimated by the stop position estimation unit 31. In this case, the travel control unit 32 may gently decelerate the vehicle 1 from a position on a near side relative to the stop position SL such that “rapid deceleration” accompanied by a deceleration of a predetermined value or more does not occur.

However, the control device 30 does not necessarily include the travel control unit 32. For example, the control device 30 may be configured to notify the occupant of the vehicle 1 that the stop position SL is close via the alarm device 90 or the like when the vehicle 1 approaches the stop position SL estimated by the stop position estimation unit 31 (for example, when a distance to the stop position SL becomes equal to or less than a threshold). That is, the stop position SL estimated by the stop position estimation unit 31 can be used for various types of vehicle control, not limited to the deceleration control described above.

### Stop Position Estimation by Stop Position Estimation Unit

The estimation of the stop position SL by the stop position estimation unit 31 will be described in more detail below with reference to FIGS. 2 to 7. In the following, as an example, a situation will be described in which the vehicle 1 passes through the intersection IS as illustrated in FIG. 2.

### Example of Assumed Situation

In order to simplify and clarify the following description, first, an example of a situation assumed in the present embodiment will be described. In the present embodiment, for example, a situation is assumed in which the vehicle 1 passes through the intersection IS as illustrated in FIGS. 2 to 7.

Here, the intersection IS is an intersection where the traveling road R1 and the crossing road R2 intersect. For example, in the example illustrated in FIG. 2 and the like, the intersection IS is a T-junction (in other words, a three-way intersection) where the crossing road R2 is connected to the traveling road R1. However, the intersection IS is not limited to a T-junction, and may be a four-way intersection, a roundabout, or the like.

The traveling road R1 is a road on which the vehicle 1 is currently traveling, and has a first lane L11 that is a lane in which the vehicle 1 is currently traveling (that is, a host lane) and a second lane L12 whose traveling direction is opposite to that of the first lane L11. The traveling direction of the first lane L11 of the traveling road R1 is a direction from the lower side to the upper side in FIGS. 2 to 7. The traveling direction of the second lane L12 of the traveling road R1 is a direction from the upper side to the lower side in FIGS. 2 to 7. In addition, the first lane L11 and the second lane L12 are separated by a center division line CL.

The crossing road R2 is a road different from the traveling road R1 and is a road intersecting with the traveling road R1. In the example illustrated in FIG. 2 and the like, the crossing road R2 is a road on the left side of the traveling road R1, extends in a width direction of the traveling road R1, and intersects with the traveling road R1 at the intersection IS.

The crossing road R2 has, for example, a first lane L21 and a second lane L22 whose traveling direction is opposite to that of the first lane L21. The traveling direction of the first lane L21 of the crossing road R2 is a direction from the left side to the right side in FIGS. 2 to 7. The traveling direction of the second lane L22 of the crossing road R2 is a direction from the right side to the left side in FIGS. 2 to 7. In addition, the first lane L21 and the second lane L22 are separated by a center division line CL.

A predetermined road surface mark may be provided near the intersection IS to indicate to vehicles passing that intersection that the vehicles should stop (including temporary stop). Examples of such a road surface mark include a stop line St, which is made up of white lines drawn on the road, and a character mark Mk, which is made up of a character such as “Stop”, “STOP”, or “Yield” drawn on the road.

In the example illustrated in FIG. 2 and the like, the stop line St and the character mark Mk of “Stop” are provided on the near side relative to the intersection IS on the traveling road R1. Here, the character mark Mk of “Stop” is a road surface mark indicating that, for example, vehicles traveling on the traveling road R1 (specifically, the first lane L11) must stop temporarily on the near side relative to the intersection IS. Similarly, the stop line St is provided on the near side relative to the intersection IS on the crossing road R2.

A road such as the traveling road R1 may be provided with a pedestrian crossing Pc as the road surface mark. The pedestrian crossing Pc is made up of a rectangle or the like having a striped pattern formed by a plurality of white lines drawn on the road. In the example illustrated in FIG. 2 and the like, the pedestrian crossing Pc is provided on the near side relative to the intersection IS on the traveling road R1.

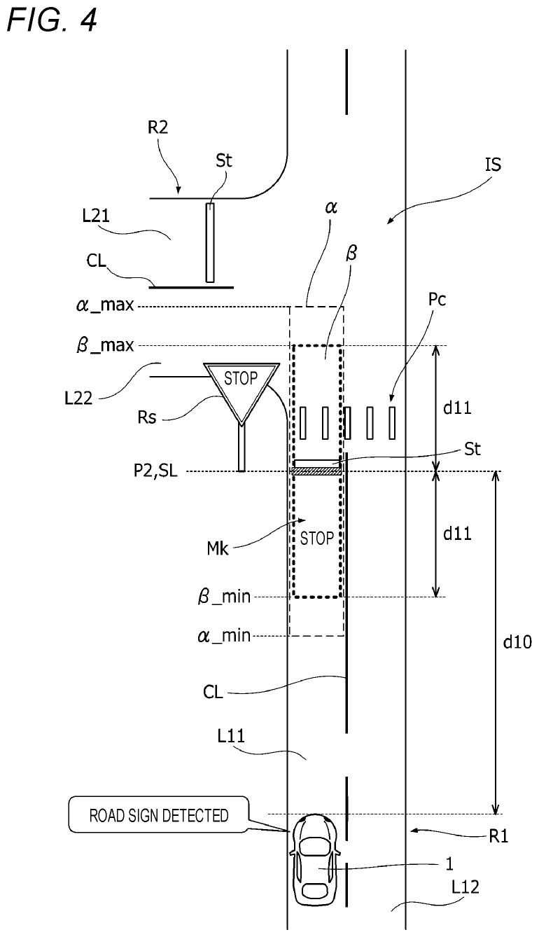

A predetermined road sign may be provided on or near a road such as the traveling road R1. For example, when the stop line St is provided on the road, a road sign Rs may be provided near the stop line St to indicate that vehicles should stop (for example, make a temporary stop) at the stop line St. In the present embodiment, as illustrated in FIG. 4, the road sign Rs, which is a signboard with a word “Stop” written thereon, is provided near the stop line St provided on the traveling road R1.

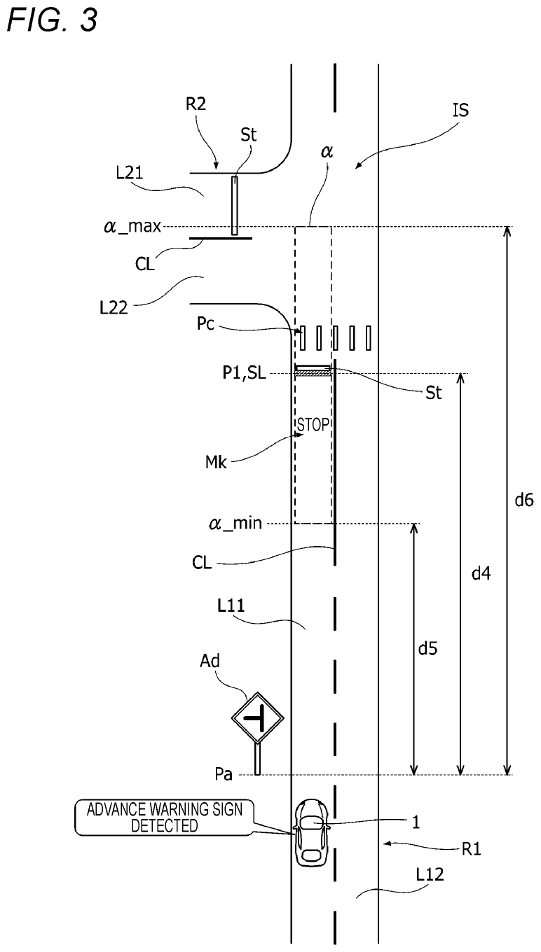

When a road such as the traveling road R1 has a location where vehicles traveling on the road should stop, an advance warning sign Ad that warns in advance of the presence of the location where vehicles should stop may be provided on the near side relative to the location where vehicles should stop. Generally, such an advance warning sign Ad is often provided on the near side at a distance corresponding to a speed limit of the road including the location where vehicles should stop from that location. In the present embodiment, as illustrated in FIG. 3, the advance warning sign Ad, which is a signboard warning in advance of the presence of the location where vehicles should stop (for example, a T-junction) on the near side relative to the intersection IS on the traveling road R1.

### Stop Position Estimation When No Advance Warning Sign, Road Sign, or Road Surface Mark Detected

The situation illustrated in FIG. 2 is a situation in which the vehicle 1 is traveling at a position quite far from the intersection IS on the near side, and therefore the external environment sensor 11 is unable to detect not only road surface marks such as the pedestrian crossing Pc, stop line St, and character mark Mk on the traveling road R1, but also the advance warning sign Ad and road sign Rs. In other words, it is a situation in which the control device 30 is unable to recognize any of the pedestrian crossing Pc, stop line St, character mark Mk, advance warning sign Ad, and road sign Rs.

In such a case, the stop position estimation unit 31 estimates the stop position SL of the vehicle 1 at the intersection IS based on the map information DB 24. Specifically, as illustrated in FIG. 2, the stop position estimation unit 31 uses the position of the intersection IS indicated by an intersection node Nx, which is a node corresponding to the intersection IS, as a reference, and estimates, as the stop position SL, a position on the near side at a distance that is a sum of a first adjustment distance d1 corresponding to the number of lanes of the crossing road R2 and a predetermined second adjustment distance d2 corresponding to a corner cut of the intersection IS (that is, d1+d2) from the intersection IS. The number of lanes of the crossing road R2 can be acquired by, for example, referring to information indicating the number of lanes set in a link corresponding to the crossing road R2 in the road network information included in the map information DB 24.

As an example, if a width of one lane on the crossing road R2 is w and the number of lanes on the crossing road R2 is n, the first adjustment distance d1 can be obtained as n/2×w. In this case, w can be set to, for example, 4 m, taking into account a width of a typical lane. However, the method for obtaining the first adjustment distance d1 is not limited thereto, and can be freely determined by a manufacturer of the vehicle 1 or the like.

The second adjustment distance d2 can be set to, for example, 5 m, taking into account a typical corner cut at an intersection. However, the second adjustment distance d2 is not limited thereto, and can be freely determined by the manufacturer of the vehicle 1 or the like in the same manner as the first adjustment distance d1. The second adjustment distance d2 may also be set to 0 (zero). In this case, the stop position estimation unit 31 may use the position of the intersection IS indicated by the intersection node Nx as a reference and estimate a position on the near side at the first adjustment distance d1 from the intersection IS as the stop position SL.

When the stop position estimation unit 31 estimates the stop position SL based on the map information DB 24, a predetermined range on the traveling road R1 ahead of and behind the stop position SL in the traveling direction is set as a first range α. Specifically, in this case, the stop position estimation unit 31 sets a position on the near side at a predetermined distance d3 from the stop position SL estimated based on the map information DB 24 as a position α_min, which is a position of a near side boundary of the first range α. The stop position estimation unit 31 also sets a position on a far side at the distance d3 from the stop position SL estimated based on the map information DB 24 as a position α_max, which is a position of a far side boundary of the first range α. Then, the stop position estimation unit 31 sets a range from the position α_min to the position α_max as the first range α.

The above distance d3 is preferably set to a value such that the pedestrian crossing Pc, the stop line St, the road sign Rs and the like provided on the near side relative to the intersection IS on the traveling road R1 is included in the first range α while also considering an error or the like of the map information DB 24 (for example, an SD map), and can be set to, for example, 10 m. However, the distance d3 is not limited thereto, and can be freely determined by, for example, the manufacturer of the vehicle 1.

In this way, the stop position estimation unit 31 uses the position of the intersection IS between the traveling road R1 and the crossing road R2 (for example, the intersection node Nx) as a reference based on the map information DB 24 (for example, an SD map), and estimates, as the stop position SL, a position on the near side at a distance, which is the sum of the first adjustment distance d1 corresponding to the number of lanes of the crossing road R2 and the second adjustment distance d2 corresponding to the corner cut of the intersection IS, from the intersection IS. In this way, it is possible to estimate an appropriate position as the stop position SL of the vehicle 1 at the intersection IS between the traveling road R1 and the crossing road R2, even if information on the stop line St is not included in the map information DB 24.

Since the stop position estimation unit 31 (that is, the control device 30) can estimate the stop position SL based on the map information DB 24, it is possible to estimate the stop position SL even if the stop line St is not detected by the external environment sensor 11 provided in the vehicle 1. Further, it is possible to improve traffic safety and contribute to development of a sustainable transportation system.

### Stop Position Estimation When Advance Warning Sign is Detected

The situation illustrated in FIG. 3 is, for example, a situation after a predetermined time has elapsed since the situation illustrated in FIG. 2, and is a situation in which the advance warning sign Ad can be detected by the external environment sensor 11 since the vehicle 1 is closer to the intersection IS than in the situation illustrated in FIG. 2. However, in the situation illustrated in FIG. 3, the road surface mark such as the pedestrian crossing Pc, the stop line St, or the character mark Mk provided on the traveling road R1, and the road sign Rs still cannot be detected, which is the same as in the situation illustrated in FIG. 2.

In this way, when the advance warning sign Ad is detected by the external environment sensor, the stop position estimation unit 31 estimates, as the stop position SL, a first position P1 on the far side relative to the detected advance warning sign Ad at a distance corresponding to a speed limit V of the traveling road R1. In this case, the stop position estimation unit 31 sets a predetermined range ahead of and behind the first position P1 in the traveling direction on the traveling road R1 as the first range α.

Specifically, it is assumed that the speed limit V of the traveling road R1 is Va km/h. In this case, as illustrated in FIG. 3, the stop position estimation unit 31 sets, as the first position P1, a position on the far side at a distance d4, which is a predetermined distance corresponding to Va km/h as the speed limit V of the traveling road R1, from a position Pa in the traveling direction of the vehicle 1 of the detected advance warning sign Ad, and estimates the first position P1 as the stop position SL.

Furthermore, the stop position estimation unit 31 estimates a position on the far side at a distance d5, which is a predetermined distance corresponding to Vb km/h, from the position Pa of the advance warning sign Ad as the position α_min of the near side boundary of the first range α. Here, Vb km/h is a predetermined speed lower than Va km/h, which is the speed limit V of the traveling road R1, and can be, for example, Va-N km/h (where N is a natural number equal to or greater than 1).

The stop position estimation unit 31 also estimates a position on the far side at a distance d6, which is a predetermined distance corresponding to Vc km/h, from the position Pa of the advance warning sign Ad, as the position α_max of the far side boundary of the first range α. Here, Vc km/h is a predetermined speed higher than Va km/h, which is the speed limit V of the traveling road R1, and can be set to, for example, Va +N km/h. Then, the stop position estimation unit 31 sets a range from the position α_min to the position α_max as the first range α.

In this case, if the first range α has already been set based on the map information DB 24, the stop position estimation unit 31 may update to the first range α based on the detected advance warning sign Ad. There may be a case where the above-mentioned intersection node Nx is not included in the map information DB 24. Even in such a case where the intersection node Nx is not included in the map information DB 24, in response to the detection of the advance warning sign Ad, the stop position estimation unit 31 can set the first range α based on the advance warning sign Ad.

Note that the distances corresponding to the respective speed limits, including the distances d4 to d6, can be freely determined by the manufacturer of the vehicle 1 or the like. For example, the manufacturer of the vehicle 1 can improve the estimation accuracy of the stop position SL by determining the distance according to each speed limit taking into account an installation rule for the advance warning sign Ad.

In this way, the stop position estimation unit 31 is configured to estimate the stop position SL based on the detection result of the external environment sensor 11 provided in the vehicle 1 and the map information DB 24. In addition, when the external environment sensor 11 detects the advance warning sign Ad that is provided on the near side relative to the location where the vehicle 1 should stop and warns in advance of the presence of the location where the vehicle 1 should stop, the stop position estimation unit 31 estimates the first position P1 on the far side relative to the detected advance warning sign Ad at a distance corresponding to the speed limit V of the traveling road R1 as the stop position SL.

That is, in general, the advance warning sign Ad is provided on the near side at a distance corresponding to the speed limit of the road including the location where the vehicle 1 and the like should stop (for example, the intersection IS) from that location. Therefore, when the advance warning sign Ad is detected by the external environment sensor 11, the stop position estimation unit 31 estimates the first position P1 on the far side relative to the advance warning sign Ad at a distance corresponding to the speed limit V of the traveling road R1 as the stop position SL, thereby accurately estimating the stop position SL taking into account the installation rule for the advance warning sign Ad.

### Stop Position Estimation When Road Sign is Detected

The situation illustrated in FIG. 4 is, for example, a situation after a predetermined time has elapsed since the situation illustrated in FIG. 3, and is a situation in which the road sign Rs can be detected by the external environment sensor 11 since the vehicle 1 is closer to the intersection IS than in the situation illustrated in FIG. 3. However, in the situation illustrated in FIG. 4, the road surface mark such as the pedestrian crossing Pc, the stop line St, or the character mark Mk provided on the traveling road R1 still cannot be detected, which is the same as in the situation illustrated in FIG. 3. In the following, the first range α is assumed as being set before the road sign Rs is detected.

Thus, when the road sign Rs is detected by the external environment sensor 11 after the first range α is set, the stop position estimation unit 31 determines whether the detected road sign Rs is within the first range α. Then, if the detected road sign Rs is within the first range α, the stop position estimation unit 31 estimates a second position P2 based on the road sign Rs as the stop position SL. In this case, the stop position estimation unit 31 sets a predetermined range ahead of and behind the second position P2 in the traveling direction on the traveling road R1 as a second range β.

Specifically, as illustrated in FIG. 4, it is assumed that a road sign Rs is detected, and the position of the road sign Rs in the traveling direction of the vehicle 1 falls within the first range α. In this case, the stop position estimation unit 31 determines the position of the road sign Rs as the second position P2, and estimates the second position P2 as the stop position SL.

Furthermore, the stop position estimation unit 31 determines a position on the near side at a distance d11 from the second position P2 as a position β_min, which is a position of a near side boundary of the second range β. The stop position estimation unit 31 determines a position on the far side at the distance d11 from the second position P2 as a position β_max, which is a position of a far side boundary of the second range β. Then, the stop position estimation unit 31 sets a range from the position β_min to the position β_max as the second range β.

The distance d11 can be a distance that is determined, for example, according to a distance d10 from the vehicle 1 to the detected road sign Rs. As an example, the distance d11 is obtained as the distance d10 ×a predetermined coefficient k (where 0<k<1). Here, the coefficient k may be freely determined by the manufacturer of the vehicle 1 for example, but it is preferable that the coefficient k be a value that takes into consideration a detection error (in other words, recognition error) of the external environment sensor 11. The second range β set using such a distance d11 is an example of a range according to the distance d10 from the vehicle 1 to the road sign Rs, and may be reduced forward or backward as the vehicle 1 approaches the road sign Rs.

If a range corresponding to the distance d10 from the vehicle 1 to the road sign Rs is set as the second range β, depending on the distance d10 from the vehicle 1 to the road sign Rs, the second range β may become too small. Therefore, for example, if the value obtained by the distance d10×the coefficient k is less than a predetermined lower limit value (for example, 10 m), the stop position estimation unit 31 may set the second range β by using the second position P2 as a reference, setting a position on the near side at a distance corresponding to the lower limit value as the position β_min, and setting a position on the far side at the distance corresponding to the lower limit value as the position β_max. In this way, the second range β can be prevented from becoming too small.

In this way, if the road sign Rs is detected by the external environment sensor 11 after the first range α is set and the road sign Rs is within the first range α, the stop position estimation unit 31 estimates the second position P2 based on the road sign Rs as the stop position SL. In this way, it is possible to re-estimate the stop position SL based on the position of the road sign Rs corresponding to the advance warning sign Ad as a trigger for the setting of the first range α, thereby making it possible to estimate the stop position SL more accurately.

The stop position estimation unit 31 sets a predetermined range ahead of and behind the second position P2 in the traveling direction on the traveling road R1 as the second range β. Then, the second range β is a range according to the distance d10 from the vehicle 1 to the road sign Rs, and is reduced forward or backward as the vehicle 1 approaches the road sign Rs. As a result, as the vehicle 1 approaches the road sign Rs (that is, the location where the vehicle 1 should stop), in other words, as the possibility of detecting a road surface mark (for example, the character mark Mk) that is likely to be provided near the location where the vehicle 1 should stop increases, the second range β can be reduced. Therefore, it becomes possible to reduce a gap between the second range β and a third range γ to be described below, and it becomes possible to prevent a large deviation between the stop position SL estimated based on the second range β and the stop position SL estimated based on the third range γ to be described below.

For example, when a plurality of road signs Rs are provided near the traveling road R1, it is also conceivable that a plurality of road signs Rs may be detected by the external environment sensor 11 after the first range α is set.

Therefore, when the plurality of road signs Rs are detected by the external environment sensor 11 after the first range α is set and the plurality of road signs Rs are within the first range α, the stop position estimation unit 31 determines a position based on the road sign Rs that is closest to the vehicle 1 (in other words, the host lane) among the plurality of road signs Rs that are within the first range α as the second position P2, and estimates the stop position SL based on the second position P2. This is because the road sign Rs closest to the vehicle 1 is most likely to be the road sign Rs related to the vehicle 1 (in other words, the host lane). Therefore, by determining the position based on the road sign Rs that is closest to vehicle 1 (in other words, the host lane) among the plurality of road signs Rs within the first range α as the second position P2, it becomes possible to accurately estimate the stopping position SL based on the road sign Rs that is considered being most likely to be related to the vehicle 1.

### Stop Position Estimation When Character Mark is Detected

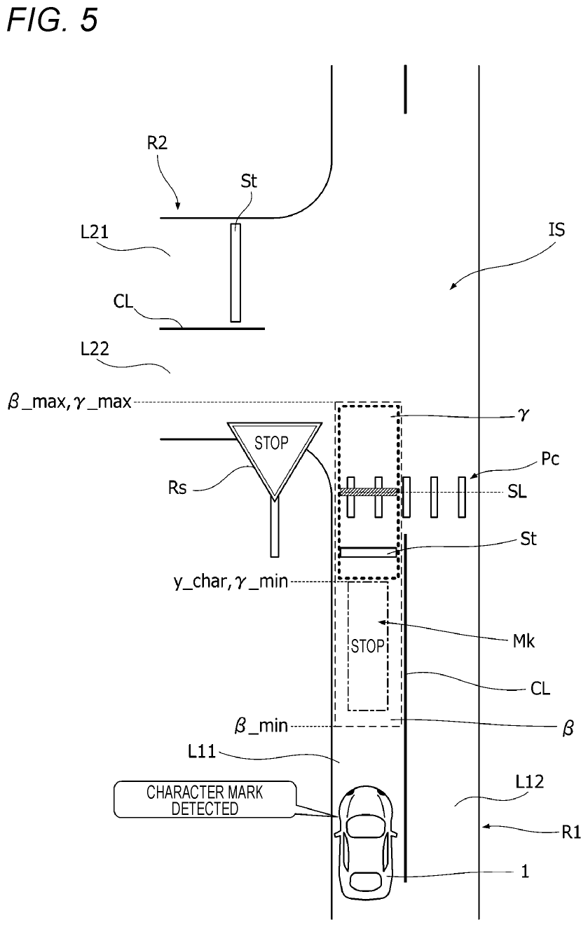

The situation illustrated in FIG. 5 is, for example, a situation after a predetermined time has elapsed since the situation illustrated in FIG. 4, and is a situation in which the character mark Mk provided on the traveling road R1 can be detected by the external environment sensor 11 since the vehicle 1 is closer to the intersection IS than in the situation illustrated in FIG. 4. However, in the situation illustrated in FIG. 5, the pedestrian crossing Pc and the stop line St provided on the traveling road R1 still cannot be detected, which is the same as in the situation illustrated in FIG. 4. In the following, the above second range β is assumed as being set before the character mark Mk is detected.

In this way, if a predetermined road surface mark is detected by the external environment sensor 11 after the second range β is set and the road surface mark is within the second range β, the stop position estimation unit 31 sets the third range γ that is smaller than the second range β based on the detected road surface mark, and estimates the stop position SL based on the third range γ.

More specifically, as illustrated in FIG. 5, it is assumed that the character mark Mk is detected as the predetermined road surface mark, and that the character mark Mk is within the second range β. In this case, the stop position estimation unit 31 determines that a position y_char of a far side end of the character mark Mk as viewed from the vehicle 1 is a position γ_min, which is a position of a near side boundary of the third range γ. In this case, the stop position estimation unit 31 determines the position β_max of the set second range β as a position γ_max, which is a position of a far side boundary of the third range γ. Then, the stop position estimation unit 31 sets the range from the position γ_min to the position γ_max as the third range γ.

Next, the stop position estimation unit 31 estimates the stop position SL based on the set third range γ. In this case, the stop position estimation unit 31 estimates, for example, a center of the set third range γ in traveling direction as the stop position SL.

In this way, if a predetermined road surface mark is detected by the external environment sensor 11 after the second range β is set and the road surface mark is within the second range β, the stop position estimation unit 31 sets the third range γ that is smaller than the second range β based on the detected road surface mark, and estimates the stop position SL based on the third range γ. Therefore, the stop position SL can be estimated from the third range γ that is narrowed down in consideration of the road surface mark such as the character mark Mk that is likely to be provided near the location where the vehicle 1 should stop. Therefore, it is possible to estimate the stop position SL with higher accuracy.

If the detected road surface mark is the character mark Mk drawn on the traveling road R1, the stop position estimation unit 31 sets the third range γ such that the position of the far side end of the character mark Mk, as viewed from the vehicle 1, is the position γ_min of the near side boundary of the third range γ.

That is, the stop line St is generally provided on the far side relative to the character mark Mk, such as “Stop” or “STOP”. Therefore, when such a character mark Mk is detected, by setting the third range γ such that the position y_char of the far side end of the character mark Mk, as viewed from the vehicle 1, is the position γ_min of the near side boundary of the third range γ, it is possible to narrow down the third range γ taking into account a general positional relation between the stop line St and the character mark Mk. Then, the stop position SL can be estimated with high accuracy from the third range γ, which is narrowed down in consideration of the general positional relation between the stop line St and the character mark Mk.

### Stop Position Estimation When Pedestrian Crossing is Detected

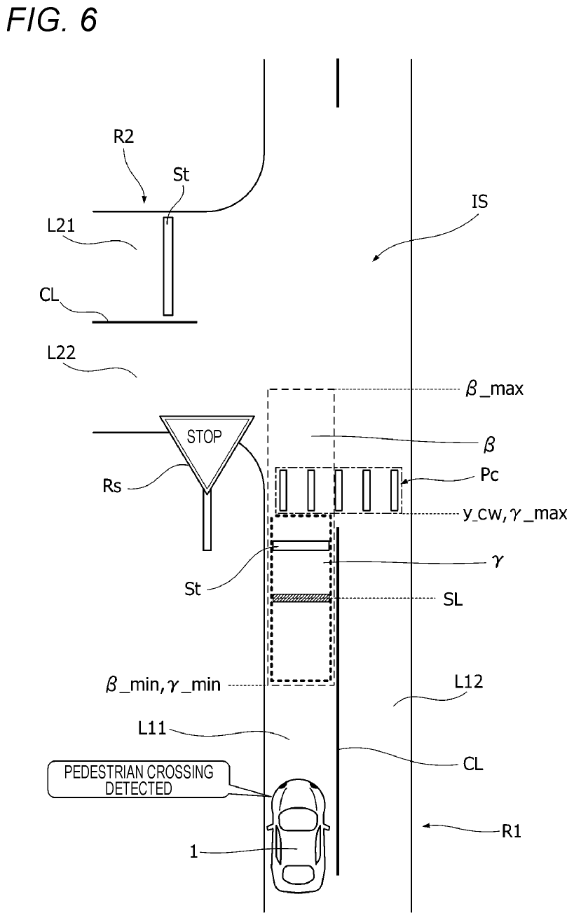

The example illustrated in FIG. 6 is an example in which, for example, the pedestrian crossing Pc provided on the traveling road R1 is detected instead of the character mark Mk in the example illustrated in FIG. 5, and is otherwise similar to the example illustrated in FIG. 5. In other words, in this example, after the second range β is set, the pedestrian crossing Pc provided on the traveling road R1 is detected by the external environment sensor 11, and the pedestrian crossing Pc is included in the second range β. For example, a situation illustrated in FIG. 6 may occur in which no character mark Mk is provided on the traveling road R1.

In this case, as illustrated in FIG. 6, the stop position estimation unit 31 may determine the position β_min of the set second range β as the position γ_min, which is the position of the near side boundary of the third range γ. In this case, the stop position estimation unit 31 may determine a position y_cw of a near side end of the detected pedestrian crossing Pc as viewed from the vehicle 1 as the position γ_max, which is the position of the far side boundary of the third range γ. Then, the stop position estimation unit 31 may set the range from the position γ_min to the position γ_max as the third range γ.

In this way, when the road surface mark detected after the second range β is set is the pedestrian crossing Pc drawn on the traveling road R1, the stop position estimation unit 31 may set the third range γ such that the position y_cw of the near side end of the pedestrian crossing Pc, as viewed from the vehicle 1, is the position γ_max of the far side boundary of the third range γ.

That is, in general, the stop line St is provided on the near side relative to the pedestrian crossing Pc. Therefore, when the detected road surface mark is the pedestrian crossing Pc, by setting the third range γ such that the position y_cw of the near side end of the pedestrian crossing Pc as viewed from the vehicle 1 is the position γ_max of the far side boundary of the third range γ, it becomes possible to accurately estimate the stop position SL from the third range γ that has been narrowed down in consideration of the installation rule for the pedestrian crossing Pc (in other words, a general positional relation between the stop line St and the pedestrian crossing Pc).

### Stop Position Estimation When Character Mark and Pedestrian Crossing are Detected

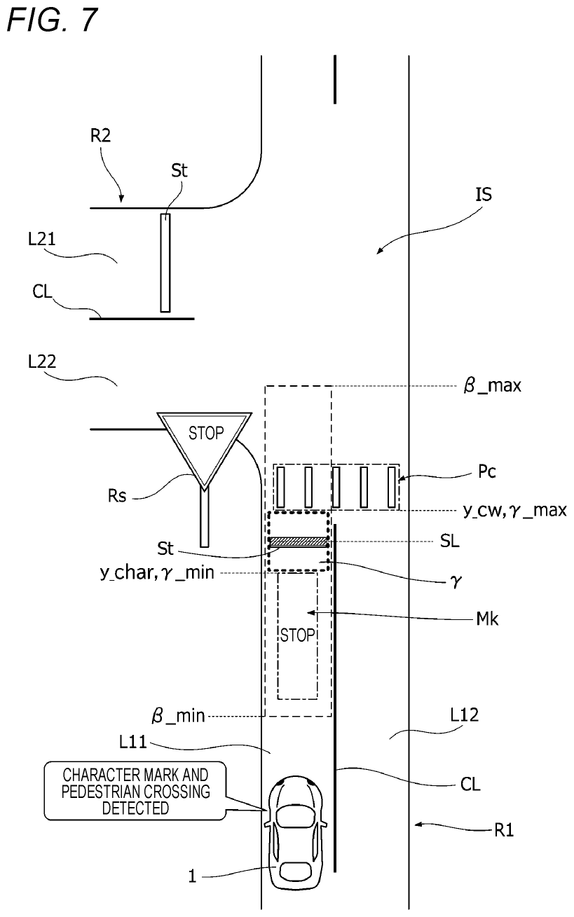

The example illustrated in FIG. 7 is an example in which both the character mark Mk and the pedestrian crossing Pc provided on the traveling road R1 can be detected. However, in the example illustrated in FIG. 7, the stop line St provided on the traveling road R1 cannot be detected, as in the examples illustrated in FIG. 5 or 6.

In this case, as illustrated in FIG. 7, the stop position estimation unit 31 may determine that the position y_char of the far side end of the detected character mark Mk as viewed from the vehicle 1 is the position γ_min, which is the position of the near side boundary of the third range γ. In this case, the stop position estimation unit 31 may determine a position y_cw of a near side end of the detected pedestrian crossing Pc as viewed from the vehicle 1 as the position γ_max, which is the position of the far side boundary of the third range γ. Then, the stop position estimation unit 31 may set the range from the position γ_min to the position γ_max as the third range γ.

In this way, after setting the second range β, if the character mark Mk and the pedestrian crossing Pc provided on the traveling road R1 are detected by the external environment sensor 11, the stop position estimation unit 31 sets the third range γ such that, as viewed from the vehicle 1, the position y_char of the far side end of the detected character mark Mk is the position γ_min of the near side boundary of the third range γ, and the position y_cw of the near side end of the detected pedestrian crossing Pc is the position γ_max of the far side boundary of the third range γ, thereby making it possible to accurately estimate the stop position SL from the narrowed down third range γ.

Note that in the examples illustrated in FIGS. 5 to 7, the description has been given on the assumption that the second range β has been set, but the present invention is not limited thereto. For example, since the second range β is set in response to the detection of the road sign Rs, it is possible that the character mark Mk or the pedestrian crossing Pc is detected when the second range β is not set, such as when no road sign Rs is detected (for example, when no road sign Rs is provided). In such a case, the stop position estimation unit 31 may use the first range α instead of the second range β to perform the same processing as in the examples illustrated in FIGS. 5 to 7.

That is, if a predetermined road surface mark is detected by the external environment sensor 11 after the first range α is set and the road surface mark is within the first range α, the stop position estimation unit 31 may set the third range γ that is smaller than the first range α based on the detected road surface mark, and estimate the stop position SL based on the third range γ. In this case, the stop position SL can also be estimated from the third range γ that is narrowed down in consideration of the road surface mark such as the character mark Mk that is likely to be provided near the location where the vehicle 1 should stop. Therefore, it is possible to estimate the stop position SL with higher accuracy.

As an example, it is assumed that the character mark Mk is detected as the predetermined road surface mark, and that the character mark Mk is within the first range α. In this case, the stop position estimation unit 31 may determine the position y_char of the far side end of the detected character mark Mk as the position γ_min of the near side boundary in the third range γ, as viewed from the vehicle 1, and may set the position α_max of the set first range α as the position γ_max of the far side boundary in the third range γ.

As another example, after the first range α is set, the pedestrian crossing Pc provided on the traveling road R1 is detected by the external environment sensor 11, and the pedestrian crossing Pc is included in the first range α. In this case, the stop position estimation unit 31 may determine the position α_min of the set first range α as the position γ_min of the near side boundary of the third range γ, and may determine the position y_cw of the near side end of the detected pedestrian crossing Pc as the position γ_max of the far side boundary of the third range γ.

When the stop line St provided on the traveling road R1 is detected by the external environment sensor 11, the stop position estimation unit 31 may estimate a position based on the detected stop line St (hereinafter also referred to as a “third position”) as the stop position SL. Then, in this case, the estimation of the stop position SL based on the map information DB 24, the advance warning sign Ad, the road sign Rs, the character mark Mk, the pedestrian crossing Pc, or the like may be ended. Here, the third position is, for example, a position where the detected stop line St is provided. In other words, since the position where the stop line St is provided is the position where the vehicle 1 and the like should stop, once the stop line St is known, there is not much point in the various estimation of the stop position SL described above. Therefore, when the stop line St provided on the traveling road R1 is detected, the position where the stop line St is provided is determined as the stop position SL, and the various estimation of the stop position SL described above is ended (in other words, stopped), thereby making it possible to obtain an appropriate stop position SL while reducing a processing burden on the control device 30.

### 3. Example of Processing Procedure by Control Device

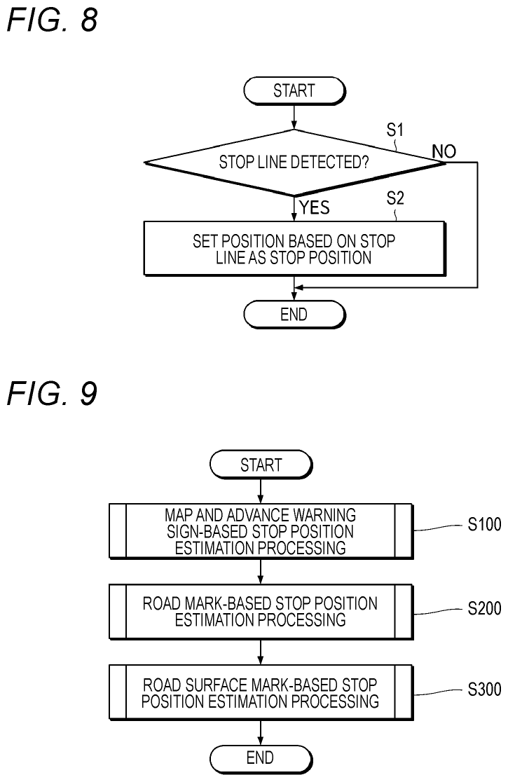

Next, an example of a processing procedure by the control device 30 will be described. FIGS. 8 to 13 are flowcharts showing the example of the processing procedure by the control device 30. For example, when an ignition power of the vehicle 1 is on, the control device 30 executes processing illustrated in FIG. 8 and processing illustrated in FIG. 9 in parallel. For example, the control device 30 repeatedly executes the processing illustrated in FIG. 8 and the processing illustrated in FIG. 9 at a predetermined cycle.

As illustrated in FIG. 8, the control device 30 determines whether the stop line St is detected by the external environment sensor 11 (step S1). If it is determined that the stop line St is not detected (step S1: NO), the control device 30 ends the series of processing illustrated in FIG. 8 directly. If it is determined that the stop line St is detected (step S1: YES), the control device 30 sets the position based on the stop line St (that is, the third position) as the stop position SL (step S2), and ends the series of processing illustrated in FIG. 8. Note that the control device 30 may stop execution of the series of processing in FIG. 9 when the position based on the stop line St is determined as the stop position SL by the processing of step S2.

In this way, when the stop line St is detected by the external environment sensor 11, the position based on the stop line St is determined as the stop position SL, making it possible to obtain the stop position SL with higher accuracy than the stop position SL estimated using the map information DB 24 or the like.

As illustrated in FIG. 9, the control device 30 sequentially executes map and advance warning sign-based stop position estimation processing S100, road mark-based stop position estimation processing S200, and road surface mark-based stop position estimation processing S300.

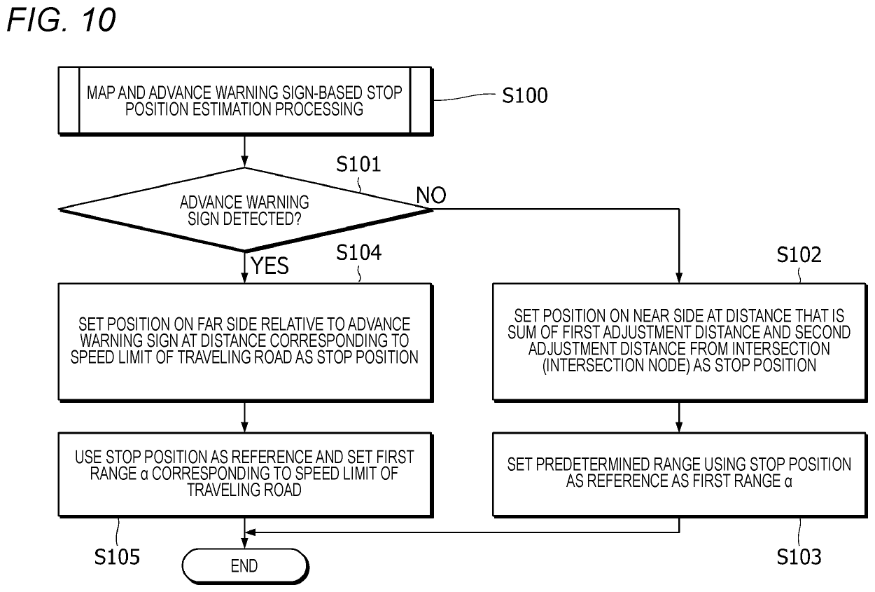

As illustrated in FIG. 10, in the map and advance warning sign-based stop position estimation processing S100, the control device 30 first determines whether the advance warning sign Ad is detected by the external environment sensor 11 (step S101). If it is determined that the advance warning sign Ad is not detected (step S101: NO), the control device 30 sets, as the stop position SL, a position on the near side at a distance that is a sum of the first adjustment distance d1 corresponding to the width of one lane and the second adjustment distance d2 corresponding to the corner cut of the intersection IS from the intersection IS (in other words, the intersection node Nx) (step S102). The control device 30 then sets a predetermined range based on the stop position SL as the first range α (step S103, see FIG. 2), and then ends the series of processing illustrated in FIG. 10.

On the other hand, if it is determined that the advance warning sign Ad is detected (step S101: YES), the control device 30 sets, as the stop position SL, the first position P1 on the far side relative to the position Pa of the advance warning sign Ad at a distance corresponding to the speed limit V of the traveling road R1 (for example, the distance d4, see FIG. 3) (step S104). The control device 30 then sets a predetermined range based on the stop position SL as the first range α (step S105, see FIG. 3), and then ends the series of processing illustrated in FIG. 10.

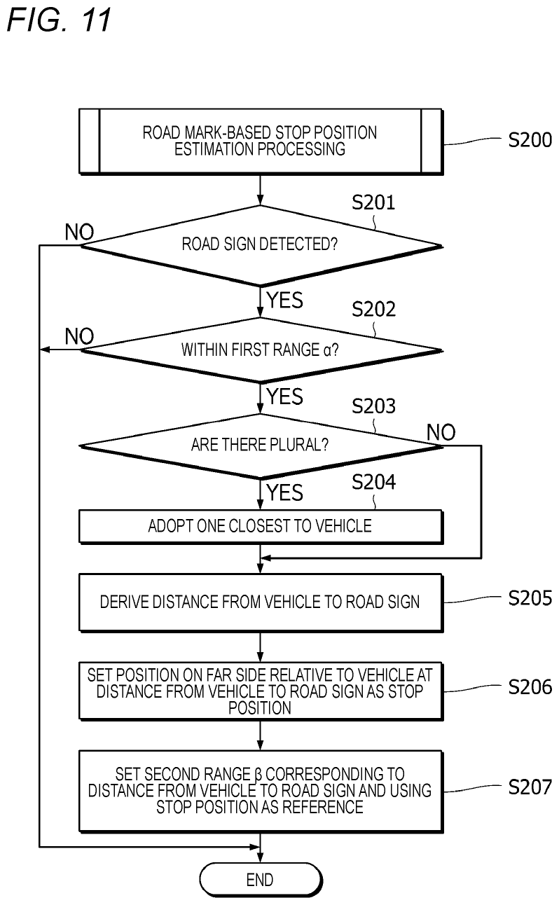

As illustrated in FIG. 11, in the road mark-based stop position estimation processing S200, the control device 30 first determines whether the road sign Rs is detected by the external environment sensor 11 (step S201). If it is determined that the road sign Rs is not detected (step S201: NO), the control device 30 ends the series of processing illustrated in FIG. 11.

On the other hand, if it is determined that the road sign Rs is detected (step S201: YES), the control device 30 determines whether the position of the detected road sign Rs is within the first range α (step S202). If it is determined that the position of the detected road sign Rs is not within the first range α (step S202: NO), the control device 30 ends the series of processing shown in FIG. 11.

If it is determined that the position of the road sign Rs is within the first range α (step S202: YES), the control device 30 determines whether there are a plurality of road signs Rs within the first range α (step S203). If it is determined that there is one road sign Rs within the first range α (step S203: NO), the control device 30 proceeds to processing of step S205.

On the other hand, if it is determined that there are a plurality of road signs Rs within the first range α (step S203: YES), the control device 30 selects the road sign Rs that is closest to the vehicle 1 among the road signs Rs within the first range α (S204) and then proceeds to processing in step S205.

Next, the control device 30 derives the distance d10 from the vehicle 1 to the road sign Rs (step S205, see FIG. 4). Then, the control device 30 sets a position on the far side relative to the vehicle 1 at the distance d10 from the vehicle 1 to the road sign Rs as the stop position SL (step S206, see FIG. 4). The control device 30 sets the second range β according to the distance d10 from the vehicle 1 to the road sign Rs based on the stop position SL (step S207, see FIG. 4), and ends the series of processing illustrated in FIG. 11.

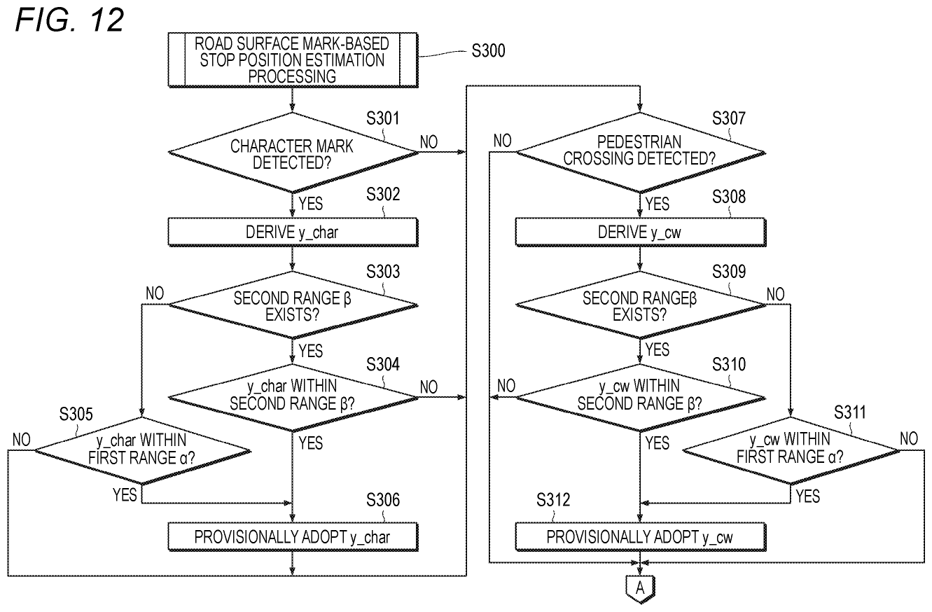

As illustrated in FIG. 12, in the road surface mark-based stop position estimation processing S300, the control device 30 first determines whether the character mark Mk is detected by the external environment sensor 11 (step S301). If it is determined that the character mark Mk is not detected (step S301: NO), the control device 30 proceeds to processing of step S307.

On the other hand, if it is determined that the character mark Mk is detected (step S301: YES), the control device 30 derives the position y_char of the far side end of the character mark Mk (step S302, see FIG. 5 and the like).

Next, the control device 30 determines whether the second range β exists (in other words, whether the second range β is set) (step S303).

If it is determined that the second range β exists (step S303: YES), the control device 30 determines whether the position y_char of the far side end of the character mark Mk is within the second range β (step S304). If it is determined that the position y_char of the far side end of the character mark Mk is outside the second range β (step S304: NO), the control device 30 proceeds to the processing of step S307.

On the other hand, if it is determined that the position y_char of the far side end of the character mark Mk is within the second range β (step S304: YES), the control device 30 provisionally adopts the position y_char of the far side end of the character mark Mk (step S306) and proceeds to the processing of step S307.

If it is determined that the second range β does not exist (step S303: NO), the control device 30 determines whether the position y_char of the far side end of the character mark Mk is within the first range α (step S305). If it is determined that the position y_char of the far side end of the character mark Mk is outside the first range α (step S305: NO), the control device 30 proceeds to the processing of step S307.

On the other hand, if it is determined that the position y_char of the far side end of the character mark Mk is within the first range α (step S305: YES), the control device 30 provisionally adopts the position y_char of the far side end of the character mark Mk (step S306) and proceeds to the processing of step S307.

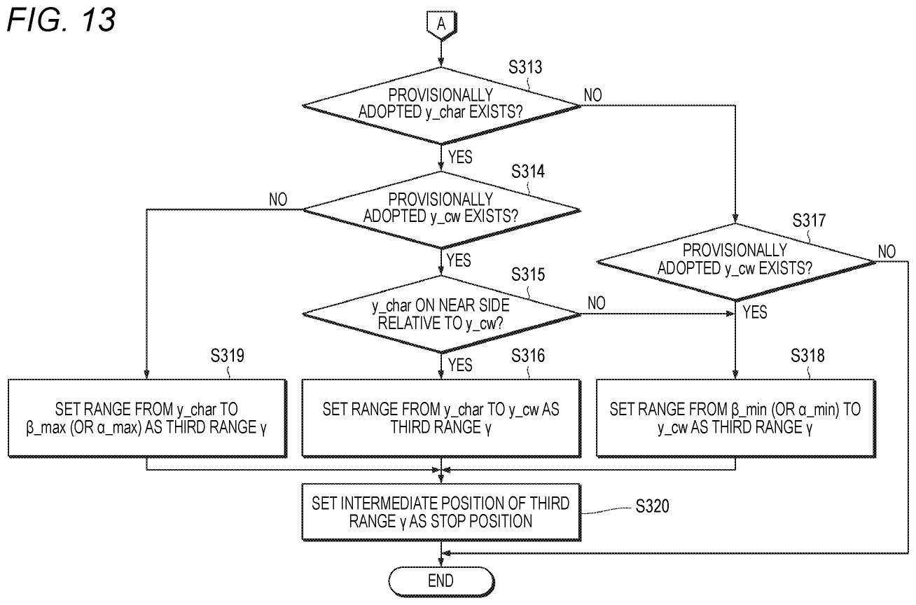

Next, the control device 30 determines whether the pedestrian crossing Pc is detected by the external environment sensor 11 (step S307). If it is determined that the pedestrian crossing Pc is not detected (step S307: NO), the control device 30 proceeds to processing of step S313 shown in FIG. 13.

On the other hand, if it is determined that the pedestrian crossing Pc is detected (step S307: YES), the control device 30 derives the position y_cw of the near side end of the pedestrian crossing Pc (step S308, see FIG. 6 and the like).

Next, the control device 30 determines whether the second range β exists (step S309). If it is determined that the second range β exists (step S309: YES), the control device 30 determines whether the position y_cw of the near side end of the pedestrian crossing Pc is within the second range β (step S310). If it is determined that the position y_cw of the near side end of the pedestrian crossing Pc is outside the second range β (step S310: NO), the control device 30 proceeds to the processing of step S313 shown in FIG. 13.

On the other hand, if it is determined that the position y_cw of the near side end of the pedestrian crossing Pc is within the second range β (step S310: YES), the control device 30 provisionally adopts the position y_cw of the near side end of the pedestrian crossing Pc (step S312), and proceeds to the processing of step S313 shown in FIG. 13.

If the control device 30 determines that the second range β does not exist (step S309: NO), the control device 30 determines whether the position y_cw of the near side end of the pedestrian crossing Pc is within the first range α (step S311). If it is determined that the position y_cw of the near side end of the pedestrian crossing Pc is outside the first range α (step S311: NO), the control device 30 proceeds to the processing of step S313 shown in FIG. 13.

On the other hand, if it is determined that the position y_cw of the near side end of the pedestrian crossing Pc is within the first range α (step S311: YES), the control device 30 provisionally adopts the position y_cw of the near side end of the pedestrian crossing Pc (step S312), and proceeds to the processing of step S313 shown in FIG. 13.

Then, as shown in FIG. 13, the control device 30 determines whether the provisionally adopted position y_char exists (step S313). If it is determined that the provisionally adopted position y_char exists (step S313: YES), the control device 30 determines whether the provisionally adopted position y_cw exists (step S314).

If it is determined that the provisionally adopted position y_cw exists (step S314:
YES), the control device 30 determines whether the provisionally adopted position y_char is on the near side relative to the provisionally adopted position y_cw (step S315). If it is determined that the provisionally adopted position y_char is not on the near side relative to the provisionally adopted position y_cw (step S315: NO), the control device 30 proceeds to processing of step S318, which will be described below. If it is determined that the provisionally adopted position y_char is on the near side relative to the provisionally adopted position y_cw (step S315: YES), the control device 30 sets a range from the position y_char to the position y_cw as the third range γ (step S316, see FIG. 7), and proceeds to processing of step S320.

In the processing of step S313, if it is determined that the provisionally adopted position y_char does not exist (step S313: NO), the control device 30 determines whether the provisionally adopted position y_cw exists (step S317). If it is determined that the provisionally adopted position y_cw does not exist (step S317: NO), the control device 30 ends the series of processing shown in FIGS. 12 and 13.

If it is determined that the provisionally adopted position y_cw exists (step S317: YES), the control device 30 sets a range from the position β_min (or the position α_min) to the position y_cw as the third range γ (step S318, see FIG. 6), and proceeds to processing of step S320. Note that in the processing of step S318, if the second range β does not exist, the control device 30 may use the first range α and set a range from the position α_min to the position y_cw as the third range γ.

If it is determined in the processing of step S314 that the provisionally adopted position y_cw does not exist (step S314: NO), the control device 30 sets a range from the position y_char to the position β_max (or the position α_max) as the third range γ (step S319, see FIG. 5), and proceeds to the processing of step S320. Note that in the processing of step S319, if the second range β does not exist, the control device 30 may use the first range α and set a range from the position y_char to the position α_max as the third range γ.

Next, the control device 30 sets an intermediate position of the third range γ set by the processing of step S316, step S318, or step S319 as the stop position SL (step S320), and ends the series of processing shown in FIGS. 12 and 13.

As described above, according to the present embodiment, it is possible to accurately estimate an appropriate stop position SL even when information on the stop line St is not included in the map information DB 24 (for example, an SD map). Further, it is possible to improve traffic safety and contribute to development of a sustainable transportation system.

Although an embodiment of the present invention has been described above, it goes without saying that the present invention is not limited to the embodiment. It is apparent that those skilled in the art can conceive of various modifications and alterations within the scope described in the claims, and it is understood that such modifications and alterations naturally fall within the technical scope of the present invention.

For example, in the above embodiment, if both the advance warning sign Ad and the intersection node Nx are acquired, the reliability of the stop position SL estimated based on the advance warning sign Ad may be determined using the stop position SL based on the intersection node Nx. In this case, the stop position SL based on the advance warning sign Ad may be determined to be highly reliable (in other words, trustworthy) on condition that the distance from the stop position SL based on the intersection node Nx to the stop position SL based on the advance warning sign Ad is less than a threshold. Furthermore, for example, any position (for example, an intermediate position) included in the range from the stop position SL based on the intersection node Nx to the stop position SL based on the advance warning sign Ad may be estimated as the stop position SL.

In the present specification, at least the following matters are described. Although corresponding constituent elements and the like in the above embodiment are shown in parentheses, the present invention is not limited thereto.
(1) A stop position estimation device (control device 30) that estimates a stop position (stop position SL) of a vehicle (vehicle 1) based on map information including information indicating a position of an intersection (intersection IS, intersection node Nx) and a number of lanes of a road connected to the intersection, the stop position estimation device including:
a processor (stop position estimation unit 31) configured to
   estimate, when a traveling road (traveling road R1) intersects with a crossing road (crossing road R2), the stop position at an intersection of the traveling road and the crossing road, the traveling road being a road on which the vehicle travels, the crossing road being a road different from the traveling road, in which
the processor
   uses a position of the intersection of the traveling road and the crossing road, based on the map information, as a reference, and
   estimates, as the stop position, a position located at a distance from the intersection on a vehicle side of the intersection, the distance being a sum of a first adjustment distance (first adjustment distance d1) according to a number of lanes of the crossing road and a predetermined second adjustment distance (second adjustment distance d2) corresponding to a corner cut of the intersection.

According to (1), based on the map information, the position of the intersection of the traveling road and the crossing road is used as a reference, and the position on the near side at a distance that is the sum of the first adjustment distance according to the number of lanes of the crossing road and the predetermined second adjustment distance corresponding to the corner cut of the intersection from the intersection is estimated as the stop position. In this way, it is possible to estimate an appropriate position as the stop position of the vehicle at the intersection of the traveling road and the crossing road, even when information on stop lines is not included in the map information. According to (1), since the stop position is estimated based on the map information, it is possible to estimate the stop position even if the stop line is not detected by the external environment sensor provided on the vehicle. In addition, it is possible to improve traffic safety and contribute to development of a sustainable transportation system.
(2) The stop position estimation device according to (1), in which
the processor is configured to estimate the stop position based on the map information and a detection result of an external environment sensor (external environment sensor 11) provided on the vehicle, and
   when the external environment sensor detects an advance warning sign (advance warning sign Ad), the warning sign provided at a location on the vehicle side of a location where the vehicle should stop and giving advance warning of presence of the location where the vehicle should stop, the processor estimates, as the stop position, a first position (first position P1) located ahead of the advance warning sign by a distance (distance d4) corresponding to a speed limit of the traveling road.

Generally, an advance warning sign is provided on the near side at a distance corresponding to a speed limit of the road including the location where the vehicle should stop from that location. According to (2), when the advance warning sign is detected by the external environment sensor of the vehicle, the first position on the far side relative to the advance warning sign at a distance corresponding to the speed limit of the traveling road is estimated as the stop position, thereby accurately estimating the stop position taking into account the installation rule for the advance warning sign.
(3) The stop position estimation device according to (2), in which
when the advance warning sign is detected by the external environment sensor, the processor sets a first range (first range α) that extends, along a traveling direction, over a predetermined range on both sides of the first position on the traveling road, and
when a predetermined road sign is (road sign Rs) detected by the external environment sensor after the first range is set and the road sign is located within the first range, the processor estimates, as the stop position, a second position (second position P2) based on the road sign.

When a road sign detected by the external environment sensor of the vehicle is within the first range, it is highly likely that the road sign is a road sign that corresponds to the advance warning sign that is a trigger for the setting of the first range and is a road sign that is provided at a location where the vehicle should stop. According to (3), when the road sign detected by the external environment sensor of the vehicle is within the first range, the second position based on that road sign is estimated as the stop position, and therefore, the stop position can be re-estimated based on the road sign corresponding to the advance warning sign that is the trigger for the setting of the first range, thereby making it possible to estimate the stop position more accurately.
(4) The stop position estimation device according to (3), in which
when a plurality of the road signs are detected by the external environment sensor after the first range is set and at least some of the plurality of the road signs are located within the first range, the processor determines a second position based on a road sign that is closest to the vehicle among the at least some of the plurality of the road signs.

According to (4), when a plurality of road signs are detected by the external environment sensor of the vehicle after the first range is set and the plurality of road signs are within the first range, the position based on the road sign that is closest to the vehicle among the plurality of road signs is set as the second position. In this way, it is possible to accurately estimate the stop position based on the road sign that is most likely to be a road sign related to the vehicle, even when a plurality of road signs are detected by the external environment sensor of the vehicle after the first range is set.
(5) The stop position estimation device according to (2), in which
when the advance warning sign is detected by the external environment sensor, the processor sets a first range (first range α) that extends, along a traveling direction, over a predetermined range on both sides of the first position on the traveling road, and
when a predetermined road surface mark (character mark Mk, pedestrian crossing Pc) is detected by the external environment sensor after the first range is set and the road surface mark is located within the first range, the processor sets, based on the road surface mark, a third range (third range γ) that is reduced from the first range and estimates the stop position based on the third range.

When a road surface mark detected by the external environment sensor of the vehicle is within the first range, there is a high possibility that the road surface mark is a road surface mark provided at a location where the vehicle should stop, which is warned of in advance by the advance warning sign that is the trigger for the setting of the first range. According to (5), when the road surface mark detected by the external environment sensor of the vehicle is within the first range, the stop position can be estimated based on the third range that is narrowed based on the road surface mark, thereby making it possible to estimate the stop position from a range narrowed down in consideration of the road surface mark. Accordingly, it is possible to estimate the stop position with higher accuracy.
(6) The stop position estimation device according to (3), in which
when the road sign is detected by the external environment sensor, the processor sets a second range (second range β) that extends, along a traveling direction, over a predetermined range on both sides of the second position on the traveling road, and
when a predetermined road surface mark (character mark Mk, pedestrian crossing Pc) is detected by the external environment sensor after the second range is set and the road surface mark is located within the second range, the processor sets, based on the road surface mark, a third range (third range γ) that is reduced from the second range and estimates the stop position based on the third range.

When the road surface mark detected by the external environment sensor of the vehicle is within the second range, it is highly likely that the road surface mark is a road surface mark provided near the road sign that is the trigger for the setting of the second range (that is, near the location where the vehicle should stop). According to (6), when the road surface mark detected by the external environment sensor of the vehicle is within the second range, the stop position can be estimated based on the third range that is narrowed based on the road surface mark, thereby making it possible to estimate the stop position from a range narrowed down in consideration of the road surface mark. Accordingly, it is possible to estimate the stop position with higher accuracy.
(7) The stop position estimation device according to (6), in which
the second range is a range corresponding to a distance (distance d10) from the vehicle to the road sign, and
the second range is reduced in both forward and backward directions as the vehicle approaches the road sign.

According to (7), by narrowing the second range forward and backward as the vehicle approaches the road sign, a gap between the second range and the third range can be reduced as the possibility of detecting the road surface mark provided near the road sign that is the trigger for the setting of the second range (that is, near the location where the vehicle should stop) increases, and it becomes possible to prevent a large deviation between the stop position estimated based on the second range and the stop position estimated based on the third range.
(8) The stop position estimation device according to (6), in which
when the road surface mark is a character mark (character mark Mk) drawn on the traveling road, the processor sets the third range such that a vehicle-side boundary of the third range is provided at a position (position γ_min) corresponding to a far end (position y_char) of the character mark, as viewed from the vehicle.

The stop line is generally provided on the far side relative to the character mark such as “Stop” or “STOP”. According to (8), when the road surface mark is a character mark, the third range is set such that the position of the far side end of the character mark as viewed from the vehicle is the position of the near side boundary of the third range, and therefore, it becomes possible to accurately estimate the stop position from the third range narrowed down in consideration of the installation rule for the character mark (in other words, a general positional relation between the stop line and the character mark).
(9) The stop position estimation device according to (6), in which
when the road surface mark is a pedestrian crossing drawn on the traveling road, the processor sets the third range such that a far-side boundary of the third range is provided at a position (position γ_max) corresponding to a near end (position y_cw) of the pedestrian crossing, as viewed from the vehicle.

In general, the stop line is provided on the near side relative to the pedestrian crossing. According to (9), when the road surface mark is a pedestrian crossing, the third range is set such that the position of the near side end of the pedestrian crossing as viewed from the vehicle is the position of the far side boundary of the third range, and therefore, it becomes possible to accurately estimate the stop position from the third range narrowed down in consideration of the installation rule for the pedestrian crossing (in other words, a general positional relation between the stop line and the pedestrian crossing).
(10) The stop position estimation device according to (6), in which
when a stop line (stop line St) is detected by the external environment sensor, the processor estimates, as the stop position, a third position based on the stop line.

According to (10), when the stop line is detected by the external environment sensor of the vehicle, the third position based on the stop line is estimated as the stop position. Accordingly, when the stop line is detected by the external environment sensor of the vehicle, it is possible to estimate the stop position with higher accuracy than the stop position estimated using the map information or the like.

What is claimed is:

1. A stop position estimation device that estimates a stop position of a vehicle based on map information including information indicating a position of an intersection and a number of lanes of a road connected to the intersection, the stop position estimation device comprising:
a processor configured to
estimate, when a traveling road intersects with a crossing road, the stop position at an intersection of the traveling road and the crossing road, the traveling road being a road on which the vehicle travels, the crossing road being a road different from the traveling road, wherein
the processor
uses a position of the intersection of the traveling road and the crossing road, based on the map information, as a reference, and
estimates, as the stop position, a position located at a distance from the intersection on a vehicle side of the intersection, the distance being a sum of a first adjustment distance according to a number of lanes of the crossing road and a predetermined second adjustment distance corresponding to a corner cut of the intersection.

2. The stop position estimation device according to claim 1, wherein
the processor is configured to estimate the stop position based on the map information and a detection result of an external environment sensor provided on the vehicle, and
when the external environment sensor detects an advance warning sign, the warning sign provided at a location on the vehicle side of a location where the vehicle should stop and giving advance warning of presence of the location where the vehicle should stop, the processor estimates, as the stop position, a first position located ahead of the advance warning sign by a distance corresponding to a speed limit of the traveling road.

3. The stop position estimation device according to claim 2, wherein
when the advance warning sign is detected by the external environment sensor, the processor sets a first range that extends, along a traveling direction, over a predetermined range on both sides of the first position on the traveling road, and
when a predetermined road sign is detected by the external environment sensor after the first range is set and the road sign is located within the first range, the processor estimates, as the stop position, a second position based on the road sign.

4. The stop position estimation device according to claim 3, wherein
when a plurality of the road signs are detected by the external environment sensor after the first range is set and at least some of the plurality of the road signs are located within the first range, the processor determines a second position based on a road sign that is closest to the vehicle among the at least some of the plurality of the road signs.

5. The stop position estimation device according to claim 2, wherein
when the advance warning sign is detected by the external environment sensor, the processor sets a first range that extends, along a traveling direction, over a predetermined range on both sides of the first position on the traveling road, and
when a predetermined road surface mark is detected by the external environment sensor after the first range is set and the road surface mark is located within the first range, the processor sets, based on the road surface mark, a third range that is reduced from the first range and estimates the stop position based on the third range.

6. The stop position estimation device according to claim 3, wherein
when the road sign is detected by the external environment sensor, the processor sets a second range that extends, along a traveling direction, over a predetermined range on both sides of the second position on the traveling road, and
when a predetermined road surface mark is detected by the external environment sensor after the second range is set and the road surface mark is located within the second range, the processor sets, based on the road surface mark, a third range that is reduced from the second range and estimates the stop position based on the third range.

7. The stop position estimation device according to claim 6, wherein
the second range is a range corresponding to a distance from the vehicle to the road sign, and
the second range is reduced in both forward and backward directions as the vehicle approaches the road sign.

8. The stop position estimation device according to claim 6, wherein
when the road surface mark is a character mark drawn on the traveling road, the processor sets the third range such that a vehicle-side boundary of the third range is provided at a position corresponding to a far end of the character mark, as viewed from the vehicle.

9. The stop position estimation device according to claim 6, wherein
when the road surface mark is a pedestrian crossing drawn on the traveling road, the processor sets the third range such that a far-side boundary of the third range is provided at a position corresponding to a near end of the pedestrian crossing, as viewed from the vehicle.

10. The stop position estimation device according to claim 6, wherein
when a stop line is detected by the external environment sensor, the processor estimates, as the stop position, a third position based on the stop line.
